(19) United States
(12) Patent Application Publication
(10) Pub. No.: US 2005/0155658 A1
(43) Pub. Date: Jul. 21, 2005

(54) Hermetically sealed pressure balanced accumulator

(76) Inventor: Andrew J. White, Port Orange, FL (US)

Correspondence Address: Iandiorio & Teska, 260 Bear Hill Road, Waltham, MA, 02451-1018, US

(21) Appl. No.: 10/760,334

(22) Filed: Jan. 20, 2004

(51) Int. Cl. F16L 55/04

(52) U.S. Cl. 138/31; 138/30

(57) ABSTRACT

A hermetically sealed pressure-balanced accumulator includes a housing and a moveable divider mechanism for separating the housing into at least an accumulator chamber at a pre-selected accumulator pressure. A first balancing chamber is responsive to changes in ambient pressure for adjusting said pre-selected accumulator pressure with respect to ambient pressure. A second balancing chamber is responsive to the first balancing chamber, and the first and second balancing chambers maintain a predetermined pressure differential between the pre-selected accumulator pressure and ambient pressure. The hermetically sealed pressure-balanced accumulator further includes a hermetic sealing device for sealing the first balancing chamber from at least one of the accumulator chamber and the second balancing chamber.

### FIELD OF THE INVENTION

This invention relates to an accumulator with improved sealing.

### BACKGROUND OF THE INVENTION

Accumulators are devices that provide a reserve of hydraulic fluid under pressure and are used in conventional hydraulically driven systems where hydraulic fluid under pressure operates equipment or a device. Depending on the load of the device to be operated, a minimum pressure level is required for successful operation. The hydraulic fluid is pressurized by a pump that maintains the high pressure required. If the pump is not operating, accumulators can be used to provide a reserve source of pressurized hydraulic fluid to enable the operation of brakes, for example, on an aircraft when the engines are not operating.

In addition, if the device is located a considerable distance from the pump, a significant pressure drop can occur in the hydraulic conduit or pipe which is conveying the fluid from the pump to operate the device. Therefore, the flow may be such that the pressure level at the device is below the pressure required to operate the device. Consequently, operation may be delayed until such a time as the pressure can build up with the fluid being pumped through the hydraulic line. This result occurs, for example, with deep water applications, such as with blowout preventer (BOP) equipment, which is used to shut off a well bore to secure an oil or gas well from accidental discharges to the environment. Thus, accumulators are used to provide a reserve source of pressurized hydraulic fluid for this type of equipment as well. Accumulators also absorb pressure spikes which occur when a component in the hydraulic system actuates or performs work.

There are many different types of accumulators. One type uses a supply of hydraulic fluid in a tank under gas pressure. In one example, a balloon bladder separates the gas from the fluid. A float type accumulator has a float providing a partial separation of the fluid from the gas and for closing a valve when the float approaches the bottom to prevent escape of fluid. In another type, a piston slides up and down a seal bore to separate the fluid from the gas.

In general, accumulators typically include a compressible fluid (gas, nitrogen, helium, air, etc.) on one side of a separator or dividing mechanism, and a non-compressible fluid (hydraulic oil) on the other side. When the hydraulic system pressure drops below the pre-charged pressure of the gas side, the dividing mechanism will move in the direction of the hydraulic side, displacing stored hydraulic fluid into the system as required.

The dividing mechanism divides the chambers and a housing separates the chambers from the outside environment. Accumulators may include a liquid chamber filled with an oil, such as hydraulic oil, and a gas chamber containing a compressed gas defined in the interior of the hollow housing. The source of the gas back charge can be either a sealed volume (pre-charge) or servo air, as known to the those of ordinary skill in the art. Examples of some known accumulators can be found in U.S. Pat. No. 6,405,760 to the assignee of this application, as well as U.S. Pat. Nos. 2,847,035, 3,076,479, 3,677,001, 4,777,800, 4,997,009, 5,638,868, 6,202,753, and 6,418,970.

Known accumulators have several shortcomings. When a gas charge is used to apply pressure on the divider, the gas charge determines the working capacity of the accumulator, and is calculated using isothermal and adiabatic models that are accurate up to 5000 p.s.i. Above 5000 p.s.i., however, the gas charge no longer behaves like an ideal gas. Thus, the gas charge must account for changes in the ambient environment as the accumulator is heated or cooled, and as the external pressure on the system changes. Large changes to the ambient conditions make the accumulator less efficient overall and ultimately unable to function. For example, in the use of sub-sea hydraulic actuators, the actuator is not only remote from the hydraulic supply which is at the surface, but there is also a substantial ambient pressure. The actual operating pressure of the accumulator is increased since the opposite side of the piston must discharge the hydraulic fluid against ambient seawater pressure. As an example, if the ambient pressure is approximately 3000 p.s.i., in order for an accumulator to provide a 3000 p.s.i. differential, the accumulator must actually be precharged to 3000 p.s.i. plus 3000 p.s.i., or 6000 p.s.i. It follows that a gas filled accumulator pressurized to 3000 p.s.i. at the surface would have the gas compressed to one half the volume at the operating depth. Therefore, only half the hydraulic fluid would be available. Alternatively, the accumulator would have to be twice as large. Consequently, the efficiency of conventional accumulators used in deep water is decreased.

Another factor to consider with the deepwater use of conventional accumulators is that the ambient temperature decreases with depth. If an accumulator is pre-charged at a surface temperature higher than the deepwater temperature, some of the pre-charge will be lost simply because the temperature was reduced. Additionally, the rapid discharge of fluids from accumulators and the associated rapid expansion of the pressurizing gas causes a natural cooling of the gas. If an accumulator is quickly reduced in pressure without an opportunity for heat to come into the accumulator (adiabatic), the pressure will drop.

One known solution to this problem is to balance the pressure load of the outside environment with a second fluid volume and gas charge or low pressure volume, such as the accumulators disclosed in U.S. Pat. No. 6,202,753, which is hereby incorporated herein by reference. In one example, fluid at ambient pressure may be added to the accumulator, increasing the pressure on the hydraulic fluid to maintain a constant pressure differential between the hydraulic fluid and ambient pressure, so the accumulator hydraulic pressure is available for doing hydraulic work.

However, in prior art pressure-balanced accumulators, the gas charge can leak into the fluid chamber, thus requiring recharging and/or causing the accumulator to become ineffective. The process of recharging accumulators can take a significant amount of time. For example, frequent and lengthy delays in operations, i.e. offshore drilling operations, contribute to substantial increases in the costs of those operations. Further difficulties may arise with regard to performing preventive maintenance on the equipment, depending on the specific application. The equipment for a particular application may be extensive in terms of components, system architecture, and complexity, and/or the accumulators may have to be removed for repair and then later reconnected. As a result, such delays to recharge the accumulator or perform preventive maintenance may be very burdensome, time-consuming, and costly.

### SUMMARY OF THE INVENTION

It is therefore an object of this invention to provide a pressure-balanced accumulator with improved sealing.

It is a further object of this invention to provide a more robust pressure-balanced accumulator.

It is a further object of this invention to provide a pressure-balanced accumulator that prevents leakage between the accumulator chambers.

It is a further object of this invention to provide a pressure-balanced accumulator that reduces the need for recharging.

The invention results from the realization that an improved pressure-balanced accumulator for providing a stored fluid reserve under pressure with increased effectiveness and which reduces the need for recharging can be achieved by providing hermetic seals to prevent leaks between the accumulator chambers.

This invention features a hermetically sealed pressure-balanced accumulator comprising a housing, a moveable divider mechanism for separating the housing into at least an accumulator chamber at a pre-selected accumulator pressure, a first balancing chamber responsive to changes in ambient pressure for adjusting the pre-selected accumulator pressure with respect to ambient pressure, and a second balancing chamber responsive to the first balancing chamber, the first and second balancing chambers maintain a predetermined pressure differential between the pre-selected accumulator pressure and ambient pressure, and a hermetic sealing device seals the first balancing chamber from at least one of the accumulator chamber and the second balancing chamber. The hermetic sealing device for sealing the first balancing chamber may include a first bellows device, and the hermetically sealed pressure-balanced accumulator may further include a hermetic sealing device for sealing the second balancing chamber from the accumulator chamber. The hermetically sealing device for sealing the second balancing chamber may include a second bellows device.

The movable divider mechanism may separate the housing into the first balancing chamber, the second balancing chamber, the accumulator chamber, and a third balancing chamber, and the third balancing chamber may be pressurized to provide the accumulator chamber with the pre-selected accumulator pressure. A hermetic sealing device may be included for sealing the third balancing chamber from the accumulator chamber, and the hermetic sealing device for sealing the third balancing chamber may include a third bellows device. The first, second and third bellows devices may include welded metal bellows. The accumulator chamber may be a hydraulic fluid chamber for storing hydraulic fluid, and the movable divider mechanism may be a piston for responding to ambient pressure changes in the first balancing chamber. The movable divider mechanism may include first and second pistons connected by a rod for responding to ambient pressure changes in the first balancing chamber.

The third balancing chamber may include pressurized fluid, which may be a gas or a liquid. The third balancing chamber may include a spring device. The first balancing chamber may include a fluid which may be a liquid or a gas. The second balancing chamber may be sealed and may include a gas chamber at a pressure lower than ambient pressure. The second balancing chamber may include a liquid chamber at a pressure lower than ambient pressure, or the second balancing chamber may be a vacuum. The second balancing chamber may include a spring device, and the third balancing chamber may be sealed.

This invention also features a hermetically sealed pressure-balanced accumulator comprising a housing, a movable divider mechanism for separating the housing into a gas chamber, a liquid chamber, and an accumulator chamber, a first bellows device for hermetically sealing the gas chamber from the accumulator chamber, and a second bellows device for hermetically sealing the liquid chamber from the accumulator chamber.

This invention also features a hermetically sealed pressure-balanced accumulator comprising a housing, a movable divider mechanism including first and second pistons connected by a rod for separating the housing into an accumulator chamber at an accumulator pressure, a first gas chamber pressurized to a pressure higher than ambient pressure for providing the accumulator chamber with accumulator pressure, a liquid chamber responsive to changes in ambient pressure for adjusting the accumulator pressure with respect to ambient pressure, and a second gas chamber at a pressure lower than ambient pressure responsive to the liquid chamber, the liquid chamber and the first and second gas chambers thereby maintaining a predetermined differential between the accumulator pressure and ambient pressure, and a first bellows device for hermetically sealing the higher pressure gas chamber from the accumulator chamber, and a second bellows device for hermetically sealing the fluid chamber from the lower pressure gas chamber.

This invention further features a hermetically sealed pressure-balanced accumulator comprising a housing, a divider mechanism for separating the housing into at least first and second balancing chambers and an accumulator chamber, and a hermetic sealing device for sealing the first balancing chamber from the accumulator chamber.

The hermetic sealing device may include a bellows. The first balancing chamber may include a fluid chamber for applying pressure to the divider mechanism. The fluid chamber may include a gas or a liquid. The second balancing chamber may include a fluid chamber which may include a gas or a liquid. The accumulator chamber may include a hydraulic fluid chamber for holding hydraulic fluid. The divider mechanism may include a piston for responding to pressure changes in the first balancing chamber.

The hermetically sealed pressure-balanced accumulator may further include a second hermetic sealing device for sealing the second balancing chamber from the accumulator chamber.

This invention also features a hermetically sealed pressure-balanced accumulator comprising a housing, a divider mechanism for separating the housing into first, second and third balancing chambers and an accumulator chamber, a first hermetic sealing device for sealing the first balancing chamber from the second balancing chamber, and a second hermetic sealing device for sealing the third balancing chamber from the accumulator chamber. The first hermetic sealing device may include a first bellows device and the second hermetic sealing device may include a second bellows device. The first balancing chamber may include a fluid chamber for applying pressure to the divider mechanism, and the fluid chamber may be a gas chamber or a liquid chamber. The second balancing chamber may include a low pressure fluid chamber, and the low pressure fluid chamber may include a gas or a liquid. The second balancing chamber may be a vacuum. The third balancing chamber may include a pressurized fluid chamber, and the pressurized fluid chamber may include a gas or a liquid. The accumulator chamber may include a hydraulic fluid chamber for holding hydraulic fluid, and the divider mechanism may include first and second pistons connected by a rod for responding to pressure changes in the first balancing chamber.

### BRIEF DESCRIPTION OF THE DRAWINGS

Other objects, features and advantages will occur to those skilled in the art from the following description of a preferred embodiment and the accompanying drawings, in which:

FIG. 1 is a schematic cross-sectional side view of a hermetically sealed pressure-balanced accumulator in accordance with this invention showing a pressurized gas chamber for providing pre-selected accumulator pressure;

FIG. 2 is a schematic cross-sectional view of the hermetically sealed pressure-balanced accumulator of FIG. 1 showing a spring device for providing pre-selected accumulator pressure;

FIG. 3 is a schematic cross-sectional side view of another hermetically sealed pressure-balanced accumulator in accordance with this invention with no initial operating pressure; and

FIGS. 4A and 4B are schematic side views of a portion of the bellows taken along the lines 4A-4A and 4B-4B of FIG. 3.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

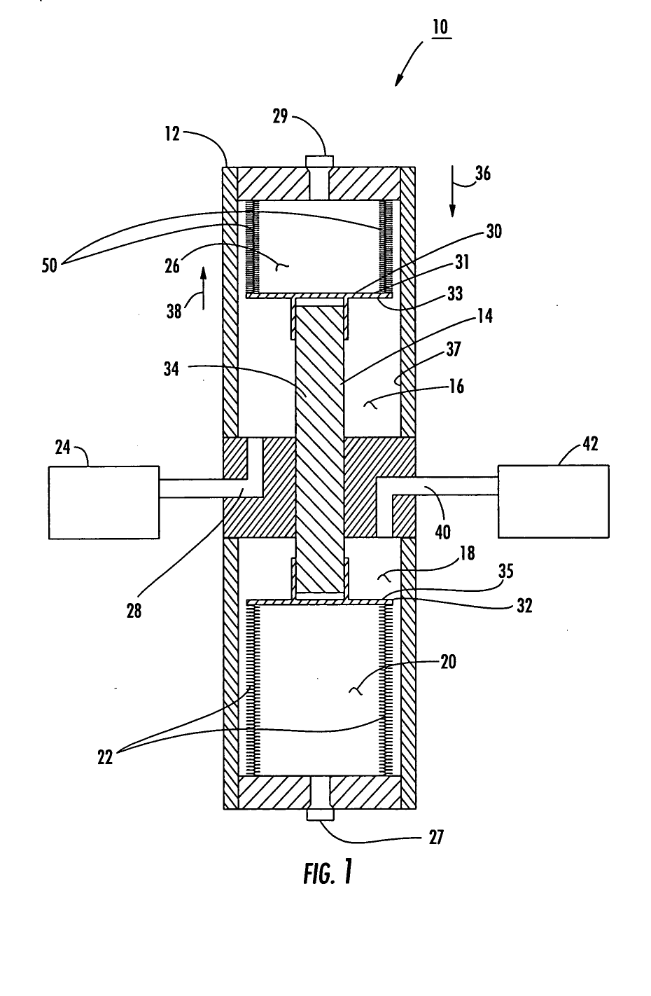

Hermetically sealed pressure balanced accumulator 10 in accordance with the present invention is shown schematically in FIG. 1. Housing 12 includes moveable divider mechanism 14 for separating housing 12 into at least accumulator chamber 16, balancing chamber 18, and balancing chamber 20. In hermetically sealed pressure balanced accumulator 10, hermetic sealing device 22 seals balancing chamber 18 from balancing chamber 20.

As discussed in the Background section above, in one example accumulator chamber 16 may be a hydraulic fluid chamber for storing hydraulic fluid. Typically, accumulator chamber 16 is at a pre-selected accumulator pressure for operating system 24, such as an aircraft braking system. The pre-selected accumulator pressure is set by balancing chamber 26. In this example, balancing chamber 26 is pressurized to provide accumulator chamber 16 with a pre-selected accumulator pressure sufficient to operate system 24. For the sake of illustration, if ambient conditions are ignored, when the pressure of system 24 drops below the pre-selected accumulator pressure, moveable divider mechanism 14 moves under the action of pressurized balancing chamber 26, displacing stored hydraulic fluid from accumulator chamber 16 to system 24. Port 28 may provide the path for the transfer of the hydraulic fluid. In this instance, moveable divider mechanism 14 includes pistons 30 and 32 connected by rod 34. When the pressure of system 24 drops below the pre-selected accumulator pressure as noted, the pressure in chamber 26 acts on surface 31 of piston 30 in the direction of arrow 36, displacing the hydraulic fluid from accumulator chamber 16 to system 24. Balancing chamber 20 includes fluid which may be a gas or a liquid under low pressure or pressure below ambient pressure and offers little or no resistance to the movement of piston 32. Balancing chamber 20 is discussed further below. Seal 27, sealing balancing chamber 20 from the external environment, is optional depending on the particular desired application, and should not be confused with the hermetic sealing devices for sealing the accumulator chambers from one another.

The operation of hermetically sealed pressure-balanced accumulator 10 of FIG. 1 is further described while still ignoring the effects of ambient pressure for purposes of illustration. When a pump in system 24 is activated, or when system 24 actuates or performs work, accumulator chamber 16 absorbs the pressurized hydraulic fluid or pressure spikes from system 24. In this case, hydraulic fluid from system 24 passes through port 28 into accumulator chamber 16. As a result of the hydraulic pump action or work performed by the hydraulic system, hydraulic fluid pressure from system 24 is higher than the pre-selected accumulator pressure of accumulator 16. Thus, accumulator 10 absorbs the spike by reverse action of moveable divider mechanism 14 and/or is restored to its ready state. In particular, hydraulic fluid from system 24 under pressure higher than the pre-selected accumulator pressure acts on surface 33 of piston 30 in the direction of arrow 38.

However, although the discussion thus far has ignored ambient conditions, changes in ambient conditions can adversely affect the operation of an accumulator as noted in the Background section above. One solution known to those of ordinary skill in the art is to provide balancing chamber 18 which is responsive to changes in ambient pressure for adjusting the pre-selected pressure of accumulator chamber 16. In operation, port 40 leads from ambient environment 42, which may include seawater in one example. When accumulator 10 is submerged and seawater enters balancing chamber 18, balancing chamber is responsive to ambient pressure changes and adjusts the pre-selected accumulator pressure with respect to ambient pressure so that the pressure exerted on accumulator chamber 16 is the sum of the pre-selected accumulator pressure provided by balancing chamber 26, plus ambient pressure provided by balancing chamber 18.

In further detail, where moveable divider mechanism 14 includes pistons 30 and 32 connected by rod 34, the pre-selected accumulator pressure provided by chamber 26 acts on surface 31 of piston 30 in the direction of arrow 36. Additionally, seawater at ambient pressure in balancing chamber 18 acts on surface 35 of piston 32, also in the direction of arrow 36. Consequently, balancing chamber 18 at ambient pressure adjusts the pre-selected accumulator pressure by the amount of ambient pressure. Balancing chamber 20 is responsive to balancing chamber 18, i.e. as ambient pressure changes, the pressure in balancing chamber 18 changes accordingly, and balancing chamber 20 allows moveable divider mechanism 14 to move to accommodate those pressure changes. Balancing chamber 20 is typically a gas under low pressure, or may be a spring.

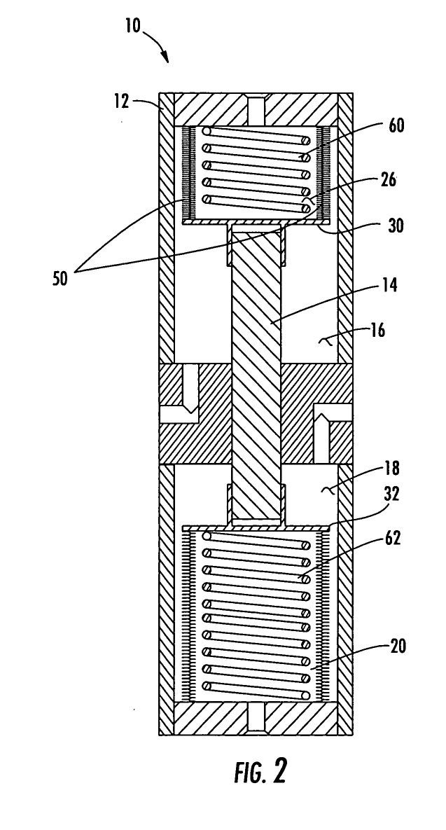

Accordingly, balancing chambers 18 and 20 maintain a pre-determined pressure differential between the pre-selected accumulator pressure and ambient pressure. The predetermined pressure differential corresponds to the pre-selected accumulator pressure, and can be considered essentially equal to the pre-selected accumulator pressure for ease of explanation. So, if balancing chamber 26 is pressurized to 3000 p.s.i., the pre-selected accumulator pressure for accumulator chamber 16 is essentially 3000 p.s.i. If ambient pressure is 3000 p.s.i., then the action of balancing chambers 16 and 20 as described herein exerts 3000 p.s.i. (resulting from pressurized balancing chamber 26) plus 3000 p.s.i. (resulting from ambient pressure), or 6000 p.s.i. (total), on accumulator chamber 16, thus maintaining the 3000 p.s.i. predetermined pressure differential (3000 p.s.i.) between the pre-selected accumulator pressure (3000 p.s.i.) and ambient pressure (3000 p.s.i.). It will be understood by those skilled in the art that the pressure in accumulator chamber 16 will be actually be less than 6000 p.s.i. by the amount of pressure in balancing chamber 20, which will be relatively negligible. Balancing chamber 26 may include seal 29 to seal balancing chamber 26 from the external environment. Seal 29 should not be confused with the hermetic sealing devices for sealing the accumulator chambers from one another. Typically, balancing chamber 26 is pressurized to a pressure higher than ambient pressure by pressurized fluid, preferably gas, or in some circumstances pressurized liquid, or spring device 60 as shown in FIG. 2. Balancing chamber 20 may include spring device 62 to assist with the compression of balancing chamber 20 as it responds to balancing chamber 18 as ambient pressure changes.

Also, it is known by those of ordinary skill in the art that the area of rod 34 may be selected to intensify the pressure in accumulator chamber 16 over the pressure of balancing chamber 26. If the area of rod 34 is ten percent of the area of bore 37, the pressure in accumulator chamber 16 will be intensified by ten percent over the pressure of balancing chamber 26. In the foregoing example, increasing the area of rod 34 by ten percent would result in a pre-selected accumulator chamber pressure of 3300 p.s.i.

In these prior art pressure balanced accumulators, however, maintaining this pre-selected accumulator pressure is problematic because leakage can occur between accumulator chamber 16 and balancing chamber 26, and/or between balancing chamber 18 and balancing chamber 20. Where balancing chamber 26 is pressurized gas, for instance, leakage necessitates re-charging or replenishing of the gas back-charge over time in order to maintain the effectiveness of the accumulator. Also, leakage between balancing chambers 18 and 20 may cause increased resistance by balancing chamber 20 (and/or decreased pressure in first chamber 18), thus adversely affecting the predetermined pressure differential desired, i.e. the balance of the pressure-balanced accumulator could be upset. In either event, there is a risk that the accumulator will not have stored energy sufficient to actuate the system, and/or down time and related costs to recharge or repair the accumulator.

The improved sealing of hermetically sealed pressure-balanced accumulator 10 of this invention, FIG. 1, resolves these problems by providing hermetic sealing device 22 for sealing balancing chamber 18 from balancing chamber 20, and hermetic sealing device 50 for sealing balancing chamber 26 from accumulator chamber 16. Hermetic sealing devices 22 and 50 may include bellows devices, examples of which can be found in U.S. Pat. No. 6,405,760 to the assignee of this application, as well as U.S. Pat. Nos. 2,847,035, 3,076,479, 3,677,001, 4,777,800, 4,997,009, 5,638,868, 6,202,753, and 6,418,970. For use with the subject invention, welded metal bellows are preferred, as described below.

Before discussing the details of hermetic sealing devices that may be employed with the subject invention, particularly welded metal bellows, the operation of another hermetically sealed pressure-balanced accumulator in which such hermetic sealing devices would provide an advantage will be described.

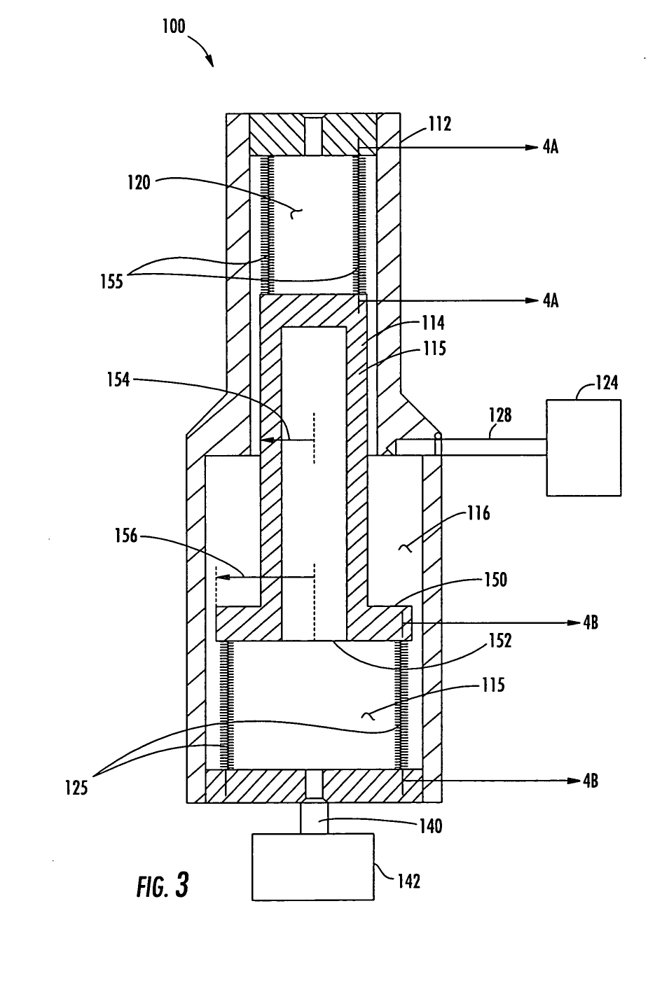

Hermetically sealed pressure-balanced accumulator 100 of this invention, FIG. 3, also resolves the aforementioned disadvantages of prior art accumulators by providing hermetic sealing device 125 for sealing balancing chamber 118 from accumulator chamber 116, and preferably also including hermetic sealing device 155 for sealing balancing chamber 120 from accumulator chamber 116. Hermetic sealing devices 125 and 155 include bellows devices, preferably welded metal bellows. Hermetically sealed pressure-balanced accumulator 100 also includes housing 112 and moveable divider mechanism 114. Moveable divider mechanism 114 separates housing 112 into at least accumulator chamber 116, balancing chamber 118, and balancing chamber 120.

In operation, hermetically sealed pressure-balanced accumulator 100 includes accumulator chamber 116 at a pre-selected accumulator pressure for operating a system. Unlike accumulator 10 discussed above, however, there is no balancing chamber to provide accumulator chamber 116 with higher than ambient pre-selected operating pressure. Thus, the accumulator operating pressure may be simply atmospheric pressure, i.e. hermetically sealed pressure-balanced accumulator 100 may have “no initial operating pressure”, as it is known to those of ordinary skill in the art. A pressure higher than ambient pressure may thereafter be provided to accumulator chamber 116 by, for example, seawater entering first balancing chamber 118 when accumulator 100 is submerged under water as described below.

Port 140 leads to balancing chamber 118 from environment 142, which may include seawater, for example. In the latter case, when ambient pressure of seawater enters balancing chamber 118, balancing chamber 118 is responsive to the changes in ambient pressure, and adjusts the pre-selected accumulator pressure with respect to ambient pressure. The amount by which the accumulator pressure is adjusted is a function of the respective annular areas 150 and 152 of moveable divider mechanism 114, which are in turn a function of the respective diameters 154 and 156. The diameters 154 and 156, and thus the areas 150 and 152, can be set as necessary for a particular application or to operate a particular system. For example, diameters 154 and 156 may be chosen so that area 152 is twice the area of 150. In that case, an increase in ambient pressure of 1500 p.s.i. in balancing chamber 118 will result in an increase of 3000 p.s.i. in the pre-selected accumulator pressure in accumulator chamber 116. Balancing chamber 120 is responsive to balancing chamber 118. As ambient pressure changes, the pressure in balancing chamber 118 changes accordingly, and balancing chamber 120 allows moveable divider mechanism 114 to move to accommodate those pressure changes. However, it will be understood by those skilled in the art that the pressure in accumulator chamber 116 will be actually be less than 3000 p.s.i. by the amount of pressure in balancing chamber 120, which will be relatively negligible. Port 128 may provide the path for the transfer of, for example, hydraulic fluid from accumulator 116 to system 124.

Accordingly, balancing chambers 118 and 120 maintain a pre-determined pressure differential between the pre-selected accumulator pressure and ambient pressure based on the chosen ratio of diameters 154 and 156 and areas 150 and 152. For hermetically sealed pressure-balanced accumulator 100, the predetermined pressure differential corresponds to the pre-selected accumulator pressure and can be considered equal to the pre-selected accumulator pressure for ease of explanation. If 3000 p.s.i. is desired to operate system 124, and ambient pressure is assumed to be 1500 p.s.i. (at a certain depth in seawater, for example) area 152 can be selected to be twice the area of 150. Therefore, at ambient pressure of 1500 p.s.i., the action of balancing chambers 116 and 120 as described herein exert 3000 p.s.i. (1500 p.s.i.×2) on accumulator chamber 116, thus maintaining, in this example, a 200 percent predetermined pressure differential between the pre-selected accumulator pressure (3000 p.s.i.) and ambient pressure (1500 p.s.i.).

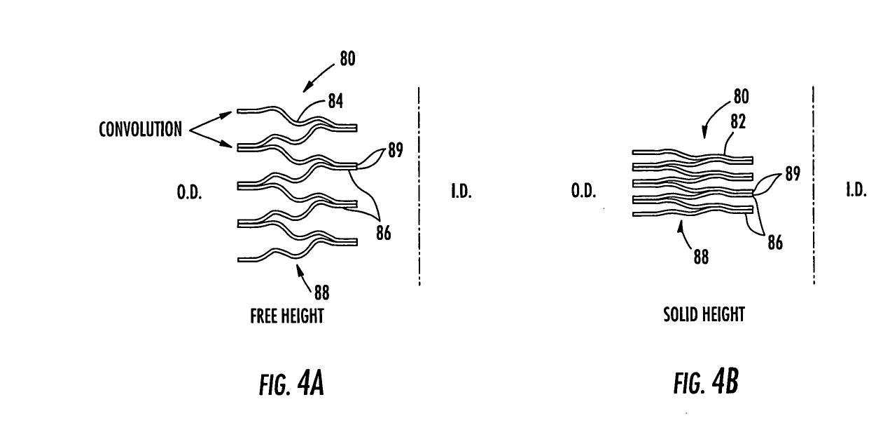

As noted above, hermetically sealed pressure balanced accumulators in accordance with this invention preferably employ welded metal bellows 80, FIGS. 4A and 4B to provide a hermetic seal between the chambers of the accumulator. As known to those skilled in the art, welded metal bellows 80 are typically compressible 82 or extendible 84. In connection with the hermetically sealed pressure-balanced accumulator of this invention as described above, one of the chambers is defined inside the bellows, with the other chambers defined outside of the bellows, and the bellows is expanded or compressed in accordance with a variation in the pressure in at least one of the chambers. A welded metal bellows with convolutions 86 comprised of diaphragms 89 nesting together and a single or multiple ripple profile 88 are preferred with the subject invention. It will be understood by those of ordinary skill in the art that the locations of the chambers including balancing chambers, accumulator chambers, and the hermetic sealing devices, relative to one another, are interchangeable, and that the relative locations of these chambers and hermetic sealing devices as shown in the figures arc not necessary limitations of the invention.

The subject invention results in a pressure-balanced accumulator with hermetic seals that prevent leakage, reduce the necessity for recharging and repair of the accumulator, and save time and costs associated with leakage, recharging and repairs.

Additionally, although specific components and uses of the hermetically sealed pressure-balanced accumulator of the subject invention are shown and discussed, it will be understood by those of ordinary skill in the art that such components and uses are not to be taken as the only possible components or uses, or combination of components and uses, and that the subject invention encompasses other combinations and embodiments, and other variations and arrangement of components and uses may occur to those of ordinary skill in the art while still coming within the penumbra of the subject invention.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A hermetically sealed pressure-balanced accumulator comprising:
a housing;
a moveable divider mechanism for separating said housing into at least an accumulator chamber at a pre-selected accumulator pressure, a first balancing chamber responsive to changes in ambient pressure for adjusting said pre-selected accumulator pressure with respect to ambient pressure, and a second balancing chamber responsive to said first balancing chamber, said first and second balancing chambers maintaining a predetermined pressure differential between said pre-selected accumulator pressure and ambient pressure; and
a hermetic sealing device for sealing said first balancing chamber from at least one of said accumulator chamber and said second balancing chamber.

2. The hermetically sealed pressure-balanced accumulator of claim 1 in which said hermetic sealing device for sealing said first balancing chamber includes a first bellows device.

3. The hermetically sealed pressure-balanced accumulator of claim 2 further including a hermetic sealing device for sealing said second balancing chamber from said accumulator chamber.

4. The hermetically sealed pressure-balanced accumulator of claim 3 in which said hermetic sealing device for sealing said second balancing chamber includes a second bellows device.

5. The hermetically sealed pressure-balanced accumulator of claim 4 in which said movable divider mechanism separates said housing into said first balancing chamber, said second balancing chamber, said accumulator chamber, and a third balancing chamber, said third balancing chamber is pressurized to provide said accumulator chamber with said pre-selected accumulator pressure.

6. The hermetically sealed pressure-balanced accumulator of claim 5 further including a hermetic sealing device for sealing said third balancing chamber from said accumulator chamber.

7. The hermetically sealed pressure-balanced accumulator of claim 6 in which said hermetic sealing device for sealing said third balancing chamber includes a third bellows device.

8. The hermetically sealed pressure-balanced accumulator of claim 7 in which said first, second and third bellows devices include welded metal bellows.

9. The hermetically sealed pressure-balanced accumulator of claim 1 in which said accumulator chamber is a hydraulic fluid chamber for storing hydraulic fluid.

10. The hermetically sealed pressure-balanced accumulator of claim 1 in which said movable divider mechanism is a piston for responding to ambient pressure changes in said first balancing chamber.

11. The hermetically sealed pressure-balanced accumulator of claim 5 in which said movable divider mechanism includes first and second pistons connected by a rod for responding to ambient pressure changes in said first balancing chamber.

12. The hermetically sealed pressure-balanced accumulator of claim 5 in which said third balancing chamber includes pressurized fluid.

13. The hermetically sealed pressure-balanced accumulator of claim 12 in which said pressurized fluid is a gas.

14. The hermetically sealed pressure-balanced accumulator of claim 12 in which said pressurized fluid is a liquid.

15. The hermetically sealed pressure-balanced accumulator of claim 5 in which said third balancing chamber includes a spring device.

16. The hermetically sealed pressure-balanced accumulator of claim 1 in which said first balancing chamber includes a fluid.

17. The hermetically sealed pressure-balanced accumulator of claim 16 in which said fluid is a liquid.

18. The hermetically sealed pressure-balanced accumulator of claim 16 in which said fluid is a gas.

19. The hermetically sealed pressure-balanced accumulator of claim 1 in which said second balancing chamber is sealed.

20. The hermetically sealed pressure balanced accumulator of claim 1 in which said second balancing chamber includes a gas chamber at a pressure lower than ambient pressure.

21. The hermetically sealed pressure balanced accumulator of claim 1 in which said second balancing chamber includes a liquid chamber at a pressure lower than ambient pressure.

22. The hermetically sealed pressure balanced accumulator of claim 1 in which said second balancing chamber is a vacuum.

23. The hermetically sealed pressure balanced accumulator of claim 1 in which said second balancing chamber includes a spring device.

24. The hermetically sealed pressure-balanced accumulator of claim 5 in which said third balancing chamber is sealed.

25. A hermetically sealed pressure-balanced accumulator comprising:
a housing;
a movable divider mechanism for separating said housing into a gas chamber, a liquid chamber, and an accumulator chamber;
a first bellows device for hermetically sealing said gas chamber from said accumulator chamber; and
a second bellows device for hermetically sealing said liquid chamber from said accumulator chamber.

26. A hermetically sealed pressure-balanced accumulator comprising:
a housing;
a movable divider mechanism including first and second pistons connected by a rod for separating said housing into an accumulator chamber at an accumulator pressure, a first gas chamber pressurized to a pressure higher than ambient pressure for providing said accumulator chamber with accumulator pressure, a liquid chamber responsive to changes in ambient pressure for adjusting said accumulator pressure with respect to ambient pressure, and a second gas chamber at a pressure lower than ambient pressure responsive to said liquid chamber, said liquid chamber and said first and second gas chambers thereby maintaining a predetermined differential between said accumulator pressure and ambient pressure;
a first bellows device for hermetically sealing said higher pressure gas chamber from said accumulator chamber; and
a second bellows device for hermetically sealing said fluid chamber from said lower pressure gas chamber.

27. A hermetically sealed pressure-balanced accumulator comprising:
a housing;
a divider mechanism for separating said housing into at least first and second balancing chambers and an accumulator chamber; and
a hermetic sealing device for sealing said first balancing chamber from said accumulator chamber.

28. The hermetically sealed pressure-balanced accumulator of claim 27 in which said hermetic sealing device includes a bellows.

29. The hermetically sealed pressure-balanced accumulator of claim 27 in which said first balancing chamber includes a fluid chamber for applying pressure to said divider mechanism.

30. The hermetically sealed pressure-balanced accumulator of claim 29 in which said fluid chamber includes a gas.

31. The hermetically sealed pressure-balanced accumulator of claim 29 in which said fluid chamber includes a liquid.

32. The hermetically sealed pressure-balanced accumulator of claim 27 in which said second balancing chamber includes a fluid chamber.

33. The hermetically sealed pressure-balanced accumulator of claim 32 in which said second balancing chamber includes a gas.

34. The hermetically sealed pressure-balanced accumulator of claim 32 in which said second balancing chamber includes a liquid.

35. The hermetically sealed pressure-balanced accumulator of claim 27 in which said accumulator chamber includes a hydraulic fluid chamber for holding hydraulic fluid.

36. The hermetically sealed pressure-balanced accumulator of claim 27 in which said divider mechanism includes a piston for responding to pressure changes in said first balancing chamber.

37. The hermetically sealed pressure-balanced accumulator of claim 28 further including a second hermetic sealing device for sealing said second balancing chamber from said accumulator chamber.

38. A hermetically sealed pressure-balanced accumulator comprising:
a housing;
a divider mechanism for separating said housing into first, second and third balancing chambers and an accumulator chamber;
a first hermetic sealing device for sealing said first balancing chamber from said second balancing chamber; and
a second hermetic sealing device for sealing said third balancing chamber from said accumulator chamber.

39. The hermetically sealed pressure-balanced accumulator of claim 38 in which said first hermetic sealing device includes a first bellows device.

40. The hermetically sealed pressure-balanced accumulator of claim 38 in which said second hermetic sealing device includes a second bellows device.

41. The hermetically sealed pressure-balanced accumulator of claim 38 in which said first balancing chamber includes a fluid chamber for applying pressure to said divider mechanism.

42. The hermetically sealed pressure-balanced accumulator of claim 41 in which fluid chamber is a gas chamber.

43. The hermetically sealed pressure-balanced accumulator of claim 41 in which fluid chamber is a liquid chamber.

44. The hermetically sealed pressure-balanced accumulator of claim 38 in which said second balancing chamber includes a low pressure fluid chamber.

45. The hermetically sealed pressure-balanced accumulator of claim 43 in which said low pressure fluid chamber includes a gas.

46. The hermetically sealed pressure-balanced accumulator of claim 43 in which said low pressure fluid chamber includes a liquid.

47. The hermetically sealed pressure-balanced accumulator of claim 43 in which said second balancing chamber is a vacuum.

48. The hermetically sealed pressure-balanced accumulator of claim 38 in which said third balancing chamber includes a pressurized fluid chamber.

49. The hermetically sealed pressure-balanced accumulator of claim 48 in which said pressurized fluid chamber includes a gas.

50. The hermetically sealed pressure-balanced accumulator of claim 48 in which said pressurized fluid chamber includes a liquid.

51. The hermetically sealed pressure-balanced accumulator of claim 38 in which said accumulator chamber includes a hydraulic fluid chamber for holding hydraulic fluid.

52. The hermetically sealed pressure-balanced accumulator of claim 38 in which said divider mechanism includes first and second pistons connected by a rod for responding to pressure changes in said first balancing chamber.
